(19) United States
(12) Patent Application Publication
(10) Pub. No.: US 2004/0110623 A1
(43) Pub. Date: Jun. 10, 2004

(54) Li2O-Al2O3-SiO2 crystallized glass and crystallizable glass and method for making the same

(76) Inventors: Kuo-Chuan Hsu, Hsin-Pu Chen (TW); Dawei Liu, Chi-Shu Kai-Fa Dist. (CN); Hairong Bao, Chi-Shu Kai-Fa Dist. (CN)

Correspondence Address: FOLEY AND LARDNER, SUITE 500, 3000 K STREET NW, WASHINGTON, DC, 20007, US

(21) Appl. No.: 10/640,573

(22) Filed: Aug. 14, 2003

(30) Foreign Application Priority Data
Aug. 14, 2002 (JP) 2002-236550

(51) Int. Cl. C03C 10/12

(52) U.S. Cl. 501/7; 65/33.9; 65/33.8

(57) ABSTRACT

An Li₂O—Al₂O₃—SiO₂ crystallizable glass comprises a base ingredient, and P₂O₅ or F. The base ingredient comprises 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O. The total content of SiO₂ and Al₂O₃ is 80.0-87.0 wt %.

### CROSS-REFERENCE TO RELATED APPLICATION

This application claims priority of Japanese Application No. 2002-236550, filed on Aug. 14, 2002.

### BACKGROUND OF THE INVENTION

1. Field of the Invention

This invention relates to Li₂O—Al₂O₃—SiO₂ crystallized glass and crystallizable glass, and more particular to Li₂O—Al₂O₃—SiO₂ transparent crystallized glass and opaque crystallized glass and method for making the same.

2. Description of the Related Art

It is known that Li₂O—Al₂O₃—SiO₂ crystallized glass (which is commonly known as Li₂O—Al₂O₃—SiO₂ glass ceramics) can be used for production of substrates for color filters and image sensors, setters for baking electronic devices, boards for microwave ovens, fire resisting window glass, front glass panels for kerosene heaters and wood stoves, and the like.

Examples of the conventional Li₂O—Al₂O₃—SiO₂ crystallized glass are disclosed in JP Patent Publication Nos. S39-21049, S40-20182, 01-308845, 06-329439, 09-188538, 2001-048582, and 2001-048583.

Li₂O—Al₂O₃—SiO₂ crystallized glass possesses high mechanical strength and excellent thermal characteristics, such as a relatively low coefficient of thermal expansion.

There are two types of Li₂O—Al₂O₃—SiO₂ crystallized glass can be formed by changing heating conditions in a crystallization process. One of which is transparent and has a β-quartz solid solution (Li₂O.Al₂O₃.nSiO₂, n≧2) produced as a main crystal therein. The other is white and opaque and has a β-spodumene solid solution (Li₂O.Al₂O₃.nSiO₂, n≧4) produced as a main crystal therein. To prepare Li₂O—Al₃O₃—SiO₂ crystallized glass having a β-quartz solid solution or a β-spodumene solid solution produced as a main crystal, the raw material is melted and is molded to form Li₂O—Al₂O₃—SiO₂ crystallizable glass which is subsequently subjected to heat treatment at an elevated temperature to have a β-quartz solid solution produced as a main crystal. To produce β-spodumene solid solution as a main crystal, the aforesaid temperature is required to be higher.

Conventionally, the temperature required to melt the raw material is normally above 1600° C. and in some cases is about 1700° C. As a consequence, an high temperature oven is needed, and a high energy consumption can not be avoided.

The temperature required to have a β-spodumene solid solution produced as a main crystal for conventional Li₂O—Al₂O₃—SiO₂ crystallizable glass is about 1000-1300, which is relatively high.

In addition, although the temperature required to have a β-quartz solid solution produced as a main crystal is lower than that of the β-spodumene solid solution, the temperature range for obtaining desired clarity or transparency of the transparent glass is relatively narrow.

### SUMMARY OF THE INVENTION

Therefore, the object of the present invention is to provide Li₂O—Al₂O₃—SiO₂ crystallizable glass formed from a raw material that can be melted at a lower temperature than those of conventional Li₂O—Al₂O₃—SiO₂ crystallizable glass.

Another object of the present invention is to provide transparent Li₂O—Al₂O₃—SiO₂ crystallized glass (a β-quartz solid solution produced as a main crystal) that possesses high mechanical strength and excellent thermal characteristics and that can be formed at a broader temperature range than those of conventional Li₂O—Al₂O₃—SiO₂ crystallizable glass.

Still another object of the present invention is to provide opaque Li₂O—Al₂O₃—SiO₂ crystallized glass (a β-spodumene solid solution produced as a main crystal) that possesses high mechanical strength and excellent thermal characteristics and that can be formed at a lower temperature than those of conventional Li₂O—Al₂O₃—SiO₂ crystallizable glass.

Still another object of the present invention is to provide a method for producing Li₂O—Al₂O₃—SiO₂ crystallizable glass.

Still another object of the present invention is to provide a method for producing transparent Li₂O—Al₂O₃—SiO₂ crystallized glass.

Yet another object of the present invention is to provide a method for producing opaque Li₂O—Al₂O₃—SiO₂ crystallized glass.

According to one aspect of the present invention, there is provided an Li₂O—Al₂O₃—SiO₂ crystallizable glass that comprises: a base ingredient comprising at least Li₂O, Al₂O₃ and SiO₂; and 0.5-4.0 wt % P₂O₅ relative to 100 wt % of the base ingredient.

According to another aspect of the present invention, there is provided an Li₂O—Al₂O₃—SiO₂ crystallizable glass that comprises: a base ingredient comprising at least Li₂O, Al₂O₃ and SiO₂; and F. In one preferred embodiment, the Li₂O—Al₂O₃—SiO₂ crystallizable glass comprises 1.0-3.0 wt % F relative to 100 wt % of the base ingredient.

According to still another aspect of the present invention, there is provided a Li₂O—Al₂O₃—SiO₂ crystallizable glass that comprises: a base ingredient comprising at least Li₂O, Al₂O₃ and SiO₂; and 0.5-4.0 wt % B₂O₅ relative to 100 wt % of the base ingredient.

The aforesaid base ingredient may further comprises TiO₂, ZrO₂, MgO, ZnO, BaO, As₂O₃, Sb₂O₃, and Na₂O+K₂O. The composition of the base ingredient comprises 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O. The total content of SiO₂ and Al₂O₃ is 80.0-87.0 wt %.

According to still another aspect of the present invention, there is provided an Li₂O—Al₂O₃—SiO₂ transparent crystallized glass having a β-quartz solid solution produced as a main crystal. The transparent crystallized glass comprises: a base ingredient comprising at least Li₂O, Al₂O₃ and SiO₂; and 0.5-4.0 wt % P₂O₅ relative to 100 wt % of the base ingredient. In one embodiment, the Li₂O—Al₂O₃—SiO₂ transparent crystallized glass further comprises 0.5-4.0 wt % B₂O₃ relative to 100 wt % of the base ingredient. In another embodiment, the Li₂O—Al₂O₃—SiO₂ transparent crystallized glass further comprises TiO₂, ZrO₂, MgO, ZnO, BaO, As₂O₃, Sb₂O₃, and Na₂O+K₂O. The composition of the base ingredient comprises 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O. The total content of SiO₂ and Al₂O₃ is 80.0-87.0 wt %.

According to still another aspect of the present invention, there is provided an Li₂O—Al₂O₃—SiO₂ opaque crystallized glass having a β-spodumene solid solution produced as a main crystal. The opaque crystallized glass comprises: a base ingredient comprising at least Li₂O, Al₂O₃ and SiO₂; and 1.0-3.0 wt % F relative to 100 wt % of the base ingredient. In one embodiment, the Li₂O—Al₂O₃—SiO₂ opaque crystallized glass further comprises 1.0-4.0 wt % B₂O₃ relative to 100 wt % of the base ingredient. In another embodiment, the Li₂O—Al₂O₃—SiO₂ opaque crystallized glass further comprises TiO₂, ZrO₂, MgO, ZnO, BaO, As₂O₃, Sb₂O₃, and Na₂O+K₂O. The composition of the base ingredient comprises 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O. The total content of SiO₂ and Al₂O₃ is 80.0-87.0 wt %.

According to still another aspect of the present invention, there is provided a method for producing Li₂O—Al₂O₃—SiO₂ crystallizable glass. The method comprises the steps of: (a) preparing a raw material by mixing a base ingredient with 0.5-4.0 wt % P₂O, relative to 100 wt % of the base ingredient, the base ingredient comprising 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O, the total content of SiO₂ and Al₂O₃ being 80.0-87.0 wt %; (b) melting the raw material; and (c) shape forming the molten raw material so as to form the Li₂O—Al₂O₃—SiO₂ crystallizable glass.

According to still another aspect of the present invention, there is provided a method for producing Li₂O—Al₂O₃—SiO₂ crystallizable glass. The method comprises the steps of: (a) preparing a raw material by mixing a base ingredient with 1.0-3.0 wt % F relative to 100 wt % of the base ingredient, the base ingredient comprising 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O, the total content of SiO₂ and Al₂O₃ being 80.0-87.0 wt %; (b) melting the raw material; and (c) shape forming the molten raw material so as to form the Li₂O—Al₂O₃—SiO₂ crystallizable glass.

According to still another aspect of the present invention, there is provided a method for producing Li₂O—Al₂O₃—SiO₂ transparent crystallized glass having a β-quartz solid solution produced as a main crystal. The method comprises the steps of: (a) preparing a raw material by mixing a base ingredient with 0.5-1.5% B₂O₃ relative to 100 wt % of the base ingredient and 0.5-4.0 wt % P₂O₅ relative to 100 wt % of the base ingredient, the base ingredient comprising 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O, the total content of SiO₂ and Al₂O₃ being 80.0-87.0 wt %; (b) heating the raw material to a temperature ranging from 1540-1600° C. for 6-15 hours so as to melt the raw material; (c) shape forming the molten raw material so as to form a Li₂O—Al₂O₃—SiO₂ crystallizable glass; (d) heating the Li₂O—Al₂O₃—SiO₂ crystallizable glass to a temperature ranging from 700-760° C. for 1-4 hours for nucleation of the Li₂O—Al₂O₃—SiO₂ crystallizable glass; and (e) heating the Li₂O—Al₂O₃—SiO₂ crystallizable glass to a temperature ranging from 800-880° C. for 1-3 hours for crystal growth of the Li₂O—Al₂O₃—SiO₂ crystallizable glass so as to form the Li₂O—Al₂O₃—SiO₂ transparent crystallized glass having a β-quartz solid solution produced as a main crystal.

According to yet another aspect of the present invention, there is provided a method for producing Li₂O—Al₂O₃—SiO₂ opaque crystallized glass having a β-spodumene solid solution produced as a main crystal. The method comprises the steps of: (a) preparing a raw material by mixing a base ingredient with 1.0-4.0% B₂O₃ relative to 100 wt % of the base ingredient and 1.0-3.0 wt % F relative to 100 wt % of the base ingredient, the base ingredient comprising 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O, the total content of SiO₂ and Al₂ O₃ being 80.0-87.0 wt %; (b) heating the raw material to a temperature ranging from 1520-1600° C. for 6-15 hours so as to melt the raw material; (c) shape forming the molten raw material so as to form a Li₂O-Al₂O₃-SiO₂ crystallizable glass; (d) heating the Li₂O—Al₂O₃—SiO₂ crystallizable glass to a temperature ranging from 640-720° C. for 0.5-2 hours for nucleation of the Li₂O—Al₂O₃—SiO₂ crystallizable glass; and (e) heating the Li₂O—Al₂O₃—SiO₂ crystallizable glass to a temperature ranging from 780-890° C. for 0.5-2 hours for crystal growth of the Li₂O—Al₂O₃—SiO₂ crystallizable glass so as to form the Li₂O—Al₂O₃—SiO₂ opaque crystallized glass having a β-spodumene solid solution produced as a main crystal.

### DETAILED DESCRIPTION OF THE PREFERRED EMBODIMENTS

This invention relates to a Li₂O—Al₂O₃—SiO₂ crystallizable glass that comprises a base ingredient and P₂O₅, or F (Fluorine), and/or B₂O₃. The base ingredient comprises 58.0-65.0 wt % SiO₂, 19.0-26.0 wt % Al₂O₃₁, 3.7-5.5 wt % Li₂O, 0.5-4.0 wt % TiO₃, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O. The total content of SiO₂ and Al₂O₃ is 80.0-87.0 wt %.

SiO₂ is a constituent for forming the crystal and the glass network. When the content of SiO₂ is less than 58.0 wt %, the coefficient of thermal expansion of the glass will be significantly increased. When the content of SiO₂ is greater than 65.0 wt %, the raw material for producing the glass will be difficult to melt.

Al₂O₃ is a constituent for forming the crystal and the glass network. When the content of Al₂O₃ is less than 19.0 wt %, the chemical resistance will be decreased and the glass will tend to devitrify. When the content of Al₂O₃ is greater than 26.0 wt %, the viscosity of the glass will be relatively high, which requires a high temperature for melting the raw material.

When the total content of SiO₂ and Al₂O₃ is leas than 80.0 wt %, the main crystal is difficult to obtain. When the total content of SiO₂ and Al₂O₃ is greater than 87.0 wt %, the temperature for melting the raw material and for subsequent shape forming will be considerably increased.

Li₂O is a component for constituting the crystal, and has a significant effect on the crystallinity of the glass, and a function of lowering the viscosity of the glass. When the total content of Li₂O is less than 3.7 wt %, the crystallinity of the glass is low and the coefficient of thermal expansion of the glass is significantly increased. When the total content of Li₂O is greater than 5.5 wt %, the glass tends to devitrify, and transparent crystallized glass is difficult to obtain.

TiO₂ is a nucleation agent. When TiO₂ is less than 0.5 wt %, the rate of nucleation will be slow. When TiO₂ is greater than 4.0 wt %, the coloration due to impurities tend to occur.

ZrO₂ is a nucleation agent. When ZrO₂ is less than 1.0 wt %, the rate of nucleation will be slow. When ZrO₂ is greater than 3.0 wt %, the temperature for melting the raw material will be considerably increased, and the glass will tend to devitrify.

MgO has an effect on improvement in melting the raw material and a function of preventing formation of bubbles. When MgO is less than 0.2 wt %, the aforesaid function is weakened and bubbles are likely to form in the glass. When MgO is greater than 3.0 wt %, the coefficient of thermal expansion of the glass will be significantly increased, the thermal characteristics is decreased, and the coloration due to impurities that results from the presence of TiO₂ will be greater, which results in an decrease in clarity.

ZnO has the same function as MgO. In addition, when ZnO is greater than 3 wt %, the dielectric loss of the crystallized glass thus formed will be significantly increased, which can result in formation of hot spot in a microwave oven during the use thereof, and the coloration due to impurities that results from the presence of TiO₂ will be greater.

BaO has the same function as MgO and ZnO. When BaO is greater than 4 wt %, the coefficient of thermal expansion of the glass will be significantly increased, the thermal characteristics will be decreased, the coloration due to impurities that results from the presence of TiO₂ will be greater, which results in an decrease in clarity, and the dielectric loss of the crystallized glass thus formed will be significantly increased.

Na₂O and K₂O have a function of improving melting of the raw material. When the total content of Na₂O and K₂O is greater than 2 wt %, the coefficient of thermal expansion of the glass will be significantly increased, and the thermal characteristics will be decreased.

As₂O₃ is a fining agent, and is capable of evolving a large amount of oxygen gas during melting at a high temperature for removing bubbles in the molten raw material. Since As₂O₃ is highly toxic, and may pollute the environment during manufacturing of the glass, the content thereof is preferably kept as small as possible. When As₂O₃ is less than 0.4 wt %, the fining effect is insufficient. When As₂O₃ is greater than 1.5 wt %, the pollution to the environment can be significant.

Sb₂O₃ has the same function as As₂O₃. In addition, Sb₂O₃ has an effect on promoting crystallization. However, the coloration due to impurities tends to occur by using Sb₂O₃ as the fining agent.

In one embodiment, the base ingredient of the aforesaid Li₂O—Al₂O₃—SiO₂ crystallizable glass is mixed with 0.5-4.0 wt % of P₂O₅, more preferably 1.5-3.0 wt % of P₂O₅, relative to 100 wt % of the base ingredient for preparation of Li₂O—Al₂O₃—SiO₂ transparent crystallized glass having a β-quartz solid solution produced as a main crystal.

P₂O₅ has a function of controlling the formation of β-quartz solid solution as the main crystal. When P₂O₅ is less than 0.5 wt %, formation of β-quartz solid solution is difficult to control. When P₂O₅ is greater than 4 wt %, the coefficient of thermal expansion of the glass will be significantly increased, which results in decrease in the thermal characteristics, and white turbidity in the transparent crystallized glass tends to occur. In the absence of P₂O₅, the temperature range for deposition of β-quartz solid solution as the main crystal is relatively narrow. With the inclusion of P₂O₅ in the raw material, the temperature range can be broadened.

In another embodiment, the base ingredient of the aforesaid Li₂O—Al₂O₃—SiO₂ crystallizable glass is mixed with 1.0-3.0 wt % of F, more preferably 1.4-2.6 wt % of F, relative to 100 wt % of the base ingredient for preparation of Li₂O—Al₂O₃—SiO₂ opaque crystallized glass having a β-spodumene solid solution produced as a main crystal.

F has a function of controlling the formation of β-spodumene solid solution as the main crystal. When F is less than 1.0 wt %, formation of β-spodumene solid solution is difficult to control. When F is greater than 3 wt %, the glass tends to devitrify. In the absence of F, a temperature of above 1000° C. is required for deposition of β-spodumene solid solution as the main crystal. With the inclusion of F in the raw material, the temperature can be reduced to about 780° C.

In yet another embodiment, the base ingredient of the aforesaid Li₂O—Al₂O₃—SiO₂ crystallizable glass is mixed with 0.5-4.0 wt % of B₂O₃ relative to 100 wt % of the base ingredient for preparation of Li₂O—Al₂O₃—SiO₂ crystallized glass. When the aforesaid Li₂O—Al₂O₃—SiO₂ transparent crystallized glass (with the inclusion of P₂O₅) is to be produced, the content of B₂O₃ is preferably 0.5-1.5 wt %. When the aforesaid Li₂O—Al₂O₃—SiO₂ opaque crystallized glass (with the inclusion of F) is to be produced, the content of B₂O₃ is preferably 1.0-4.0 wt %.

In the absence of B₂O₃, a temperature of above 1600° C., even up to 1700° C. for some cases, is required for melting the raw material. Also, the time required to melt the raw material under such high tempeature may last several hours to 20 hours. With the inclusion of B₂O₃ in the raw material, the temperature can be reduced to 1520-1600° C.

This invention also relates to a method for producing the Li₂O—Al₂O₃—SiO₂ crystallizable glass. The method comprises the steps of; (a) preparing the raw material by mixing the base ingredient with 0.5-4.0 wt % P₂O₅, or 1.0-3.0 wt % F, relative to 100 wt % of the base ingredient, the base ingredient comprising 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O, the total content of SiO₂ and Al₂O₃ being 80.0-87.0 wt %; (b) melting the raw material; and (c) shape forming the molten raw material so as to form the Li₂O—Al₂O₃—SiO₂ crystallizable glass.

Preferably, the raw material in step (a) includes 0.5-4.0 wt5 B₂O₃. As such, when the raw material in step (a) includes 0.5-4.0 wt % P₂O₅, the raw material in step (b) is preferably heated to a temperature ranging from 1540-1600° C. for 6-15 hours, and more preferably from 1570-1600° C. for 10-15 hours, and when the raw material in step (a) includes 1.0-3.0 wt % F, the raw material in step (b) is preferably heated to a temperature ranging from 1520-1600° C. for 6-15 hours, and more preferably from 1520-1600° C. for 9-15 hours.

To prepare the Li₂O—Al₂O₃—SiO₂ crystallized glass, the method further comprises heating the shaped Li₂O—Al₂O₃—SiO₂ crystallizable glass obtained from step (c) to a nucleation temperature for nucleation, followed by heating the same to a crystal-growing temperature to obtain the desired Li₂O—Al₂O₃—SiO₂ crystallized glass. Under different compositions and heating conditions, the Li₂O—Al₂O₃—SiO₂ crystallizble glass can be formed into transparent crystallized glass (i.e., the β-quartz solid solution is produced as the main crystal) or opaque crystallized glass (i.e., the β-spodumene solid solution is produced as the main crystal).

For preparation of transparent crystallized glass, P₂O₅ is included in the raw material, the nucleation temperature is preferably in a range of from 700-760° C. and the nucleation time is preferably from 1-4 hours, more preferably from 710-740° C. and from 2-4 hours, and the crystal-growing temperature is preferably in a range of from 800-880° C. and the growing time is preferably from 1-3 hours, more preferably from 840-860° C. and from 2-3 hours.

For preparation of opaque crystallized glass, F is included in the raw material, the nucleation temperature is preferably in a range of from 640-720° C. and the nucleation time is preferably from 0.5-2 hours, more preferably from 660-700° C. and from 1-2 hours, and the crystal-growing temperature is preferably in a range of from 780-890° C. and the growing time is preferably from 0.5-2 hours, more preferably from 810-890° C. and from 1-1.5 hours.

### EXAMPLES AND COMPARATIVE EXAMPLES

### Comparative Examples 1-6

The sample for each Comparative Example was prepared by the following steps.

The raw materials for the compounds listed in Table 1 was uniformly mixed. The mixture was placed in an electric oven using a platinum crucible. The mixture was heated to 1620° C. for 8-16 hours, and was melted into a molten glass. The molten glass was cast on a carbon plate, and was formed into 5 mm thick glass sheet. The glass sheet was cooled to room temperature in a cooling oven. The cooled glass sheet was then heated in an electric oven to a nucleation temperature for nucleation, and was further heated to a crystal-growing temperature for crystal growth. The heating rate was 300° C./hr from room temperature to the nucleation temperature, and was 100-200° C./hr from the nucleation temperature to the crystal growing temperature. The nucleation temperature, the crystal-growing temperature, and the duration for each Comparative Example are shown in Table 1.

Main crystal and appearance were measured for the sample of each Comparative Example. The results are shown in Table 1. The coefficient of thermal expansion for the sample of each Comparative Example was measured. The samples of Comparative Examples 1-6 have a coefficient of thermal expansion ranging from −10×10⁻⁷/° C. to 30×10⁻⁷/° C.

TABLE 1

| | Comparative Example | | | | | |
|---|---|---|---|---|---|---|
| | 1 | 2 | 3 | 4 | 5 | 6 |
| Composition, wt % | | | | | | |
| SiO₂ | 58 | 61.8 | 63 | 58 | 61.8 | 63 |
| Al₂O₃ | 26 | 23 | 21 | 26 | 23 | 21 |
| LiO₂ | 5.5 | 4 | 4.5 | 5.5 | 4 | 4.5 |
| TiO₂ | 4 | 2 | 2 | 4 | 2 | 2 |
| ZrO₂ | 1 | 3 | 2 | 1 | 3 | 2 |
| MgO | 1.5 | 1.5 | 0.5 | 1.5 | 1.5 | 0.5 |
| ZnO | — | 2 | 1.7 | — | 2 | 1.7 |
| BaO | 0.8 | 1.5 | 0.8 | 0.8 | 1.5 | 0.8 |
| B₂O₃ | 0.7 | — | 3.5 | 0.7 | — | 3.5 |
| Na₂O + K₂O | 2 | 0.7 | 0.5 | 2 | 0.7 | 0.5 |
| As₂O₃ | 0.5 | 0.5 | 0.5 | 0.5 | 0.5 | 0.5 |
| Main crystal* | β-Q | β-Q | β-Q | β-S | β-S | β-S |
| Nucleation | 800 | 800 | 800 | 800 | 800 | 800 |
| temperature, °C. | | | | | | |
| Nucleation | 2 | 2 | 2 | 2 | 2 | 2 |
| duration, hrs | | | | | | |
| Crystal-growing | 870 | 890 | 880 | 1060 | 1100 | 1080 |
| temperature, °C. | | | | | | |
| Crystal growth | 2 | 2 | 2 | 2 | 2 | 2 |
| duration, hrs | | | | | | |
| appearance | C/T^{#} | C/T | C/T | W/O⁺ | W/O | W/O |

*β-Q represents β-Quartz and β-S represents β-Spodumene.
^{#}C/T represents colorless and transparent.
⁺W/O represents white and opaque.

### Examples 1-3

### Transparent Crystallized Glass

Examples 1-3 respectively correspond to the Comparative Examples 1-3. The raw material employed in each of the Comparative Examples 1-3 was a base ingredient of a respective one of the Examples 1-3. In addition to the base ingredient, the raw material of each of the Examples 1-3 further contained P₂O₅. The contents of P₂O₅ of Examples 1-3 are shown in Table 2.

The operating conditions for preparation of the samples of Examples 1-3 was similar to those of the Comparative Examples 1-6, except that the raw material was heated to 1570° C. for 8-15 hours to form a molten glass. The nucleation temperature and duration and the crystal-growing temperature and duration for each Example are shown in Table 2.

Main crystal, coefficient of thermal expansion, and appearance were measured for the samples of Examples 1-3. The results are shown in Table 2.

TABLE 2

Example

| | 1 | 2 | 3 |
|---|---|---|---|
| Composition, wt % | | | |
| Base ingredient obtained | 1 | 2 | 3 |
| from Comparative Example | | | |
| P₂O₅ | 3.0 | 4.0 | 2.0 |
| Main crystal | β-Q | β-Q | β-Q |
| Nucleation temperature, ° C. | 700 | 700 | 700 |
| Nucleation duration, hrs | 2 | 2 | 2 |
| Crystal-growing temperature, ° C. | 840 | 880 | 850 |
| Crystal growth duration, hrs | 2 | 2 | 2 |
| C_{T}*, × 10⁻⁷/° C. | 0.3 | 1.6 | 2.2 |
| appearance | C/T | C/T | C/T |

*C_{T} represents coefficient of thermal expansion

### Examples 4-6

### Opaque Crystallized Glass

Examples 4-6 respectively correspond to the Comparative Examples 4-6. The raw material employed in each of the Comparative Examples 4-6 was a base ingredient of a respective one of the Examples 4-6. In addition to the base ingredient, the raw material of each of the Examples 4-6 further contained F. The contents of F of Examples 4-6 are shown in Table 3.

The operating conditions for preparation of the samples of Examples 4-6 was similar to those of the Comparative Examples 1-6, except that the raw material was heated to 1530° C. for 8-15 hours to form a molten glass. The nucleation temperature and duration and the crystal-growing temperature and duration for each Example are shown in Table 3.

Main crystal, coefficient of thermal expansion, and appearance were measured for the samples of Examples 4-6. The results are shown in Table 3.

TABLE 3

Example

| | 4 | 5 | 6 |
|---|---|---|---|
| Composition, wt % | | | |
| Base ingredient obtained | 4 | 5 | 6 |
| from Comparative Example | | | |
| F | 1.0 | 2.0 | 3.0 |
| Main crystal | β-S | β-S | β-S |
| Nucleation temperature, ° C. | 700 | 700 | 700 |
| Nucleation duration, hrs | 2 | 2 | 2 |
| Crystal-growing temperature, ° C. | 820 | 835 | 780 |
| Crystal growth duration, hrs | 2 | 2 | 2 |
| C_{T}, × 10⁻⁷/° C. | 14 | 16 | 10 |
| appearance | w/o | w/o | w/o |

The results of Examples 1-6 are compared to those of the Comparative Examples 1-6.

As clearly seen from Tables 1 and 2, deposition of the main crystal for Examples 1-3 can be controlled at a broader temperature range (840-880° C.) than that of the Comparative Examples 1-3 (870-890° C.), and from Tables 1 and 3, the crystal-growing temperature ranges from 780-835° C. for Examples 4-6, which is much lower than that of the Comparative Examples 4-6 (1060-1100° C.). The coefficient of thermal expansions for Examples 1-6 are respectively similar to those of the Comparative Examples 1-6.

### Comparative Examples 7-14

The raw materials employed in Comparative Examples 7-14 are shown in Table 4. The operating conditions for preparation of the samples of Comparative Examples 7-14 are similar to those of Comparative Examples 1-6, except that the raw material was heated to 1650° C. for 8-20 hours to form a molten glass. The nucleation temperature and duration and the crystal-growing temperature and duration for each Comparative Example are shown in Table 4.

Main crystal, coefficient of thermal expansion, and appearance were measured for the samples of Examples 7-14. The results are shown in Table 4.

TABLE 4

| | Comparative Example | | | | | | | |
|---|---|---|---|---|---|---|---|---|
| | 7 | 8 | 9 | 10 | 11 | 12 | 13 | 14 |
| Composition, wt % | | | | | | | | |
| SiO₂ | 63.6 | 64.6 | 65.8 | 60.6 | 63.6 | 64.6 | 65.8 | 60.6 |
| Al₂O₃ | 22.0 | 22.0 | 21.1 | 26.0 | 22.0 | 22.0 | 21.1 | 26.0 |
| LiO₂ | 4.4 | 4.5 | 4.2 | 5.1 | 4.4 | 4.5 | 4.2 | 5.1 |
| TiO₂ | 1.7 | 0.5 | 1.9 | 2.5 | 1.7 | 0.5 | 1.9 | 2.5 |
| ZrO₂ | 2.1 | 1.8 | 2.3 | 1.3 | 2.1 | 1.8 | 2.3 | 1.3 |
| MgO | — | 0.3 | 0.5 | 0.7 | — | 0.3 | 0.5 | 0.7 |
| ZnO | 0.4 | 0.4 | 1.0 | — | 0.4 | 0.4 | 1.0 | — |
| BaO | 3.3 | 3.0 | — | 2.0 | 3.3 | 3.0 | — | 2.0 |
| Sb₂O₃ | 0.5 | 0.5 | — | — | 0.5 | 0.5 | — | — |
| Na₂O | 0.5 | 0.3 | 0.5 | 0.5 | 0.5 | 0.3 | 0.5 | 0.5 |
| K₂O | 0.6 | 0.6 | 0.3 | 0.8 | 0.6 | 0.6 | 0.3 | 0.8 |
| As₂O₃ | — | 0.4 | 1.0 | 0.5 | — | 0.4 | 1.0 | 0.5 |
| Cl | — | 0.2 | — | — | — | 0.2 | — | — |
| F | — | — | — | — | — | — | — | — |
| P₂O₅ | 0.9 | 0.9 | 1.4 | — | 0.9 | 0.9 | 1.4 | — |
| B₂O₃ | — | — | — | — | — | — | — | — |
| Main crystal* | β-Q | β-Q | β-Q | β-Q | β-S | β-S | β-S | β-S |
| Nucleation | 780 | 780 | 780 | 730 | 780 | 780 | 780 | 730 |
| temperature, °C. | | | | | | | | |
| Nucleation | 2 | 2 | 2 | 2 | 2 | 2 | 2 | 2 |
| duration, hrs | | | | | | | | |
| Crystal-growing | 900 | 900 | 900 | 845 | 1160 | 1160 | 1160 | 1100 |
| temperature, °C. | | | | | | | | |
| Crystal growth | 3 | 3 | 3 | 2 | 1 | 1 | 1 | 2 |
| duration, hrs | | | | | | | | |
| appearance | C/T | C/T | C/T | C/T | W/O | W/O | W/O | W/O |
| C_{T}, × 10⁻⁷/°C. | 1.0 | 1.0 | −3.0 | 5.0 | 17.0 | 14.0 | 11.0 | 18.0 |

### Examples 7-14

The raw materials employed in Examples 7-14 are shown in Table 5. The operating conditions for preparation of the samples of Examples 7-14 are similar to those of Comparative Examples 7-14, except that the raw material was heated to 1550° C. for 10-15 hours to form a molten glass. The nucleation temperature and duration and the crystal-growing temperature and duration for each Example are shown in Table 5.

Main crystal, coefficient of thermal expansion, and appearance were measured for the samples of Examples 7-14. The results are shown in Table 5.

TABLE 5

| | Example | | | | | | | |
|---|---|---|---|---|---|---|---|---|
| | 7 | 8 | 9 | 10 | 11 | 12 | 13 | 14 |
| Composition, | | | | | | | | |
| wt % | | | | | | | | |
| Base ingredient | | | | | | | | |
| SiO₂ | 64.5 | 64.5 | 65.0 | 65.0 | 65.8 | 65.8 | 60.6 | 61.0 |
| Al₂O₃ | 22.0 | 22.0 | 22.0 | 22.0 | 21.2 | 21.2 | 26.0 | 26.0 |
| LiO₂ | 4.4 | 5.0 | 4.5 | 4.5 | 5.0 | 5.0 | 5.1 | 5.1 |
| TiO₂ | 1.7 | 1.7 | 1.0 | 1.3 | 1.9 | 1.9 | 2.5 | 2.5 |
| ZrO₂ | 2.1 | 2.1 | 1.8 | 1.8 | 2.3 | 2.3 | 1.3 | 1.3 |
| MgO | — | — | 0.3 | 0.3 | 0.5 | 0.5 | 0.7 | 0.7 |
| ZnO | 0.4 | 0.4 | 0.4 | 0.4 | 1.0 | 1.0 | — | — |
| BaO | 3.3 | 3.3 | 3.0 | 3.0 | — | — | 2.0 | 2.0 |
| Sb₂O₃ | — | — | — | — | 0.5 | 0.5 | — | — |
| Na₂O | 0.5 | 0.5 | 0.3 | — | 0.5 | 0.5 | 0.5 | 0.5 |
| K₂O | 0.6 | — | 0.6 | 0.6 | 0.3 | 0.3 | 0.8 | — |
| As₂O₃ | 0.5 | 0.5 | 1.1 | 1.1 | 1.0 | 1.0 | 0.5 | 0.9 |
| Cl | — | — | — | — | — | — | — | — |
| F* | — | 2.5 | — | 3.0 | — | 2.5 | — | 2.0 |
| P₂O₅* | 2.1 | — | 4.0 | — | 3.4 | — | 2.0 | — |
| B₂O₃* | 1.0 | 0.6 | 0.5 | 1.5 | 0.8 | 1.0 | 0.5 | 1.0 |
| Main crystal* | β-Q | β-S | β-Q | β-S | β-Q | β-S | β-Q | β-S |
| Nucleation | 700 | 660 | 710 | 670 | 720 | 680 | 730 | 690 |
| temperature, | | | | | | | | |
| °C. | | | | | | | | |
| Nucleation | 2 | 2 | 2 | 2 | 2 | 2 | 2 | 2 |
| duration, hrs | | | | | | | | |
| Crystal- | 820 | 810 | 830 | 820 | 840 | 830 | 850 | 840 |
| growing | | | | | | | | |
| temperature, | | | | | | | | |
| °C. | | | | | | | | |
| Crystal growth | 2 | 2 | 2 | 2 | 2 | 2 | 2 | 2 |
| duration, hrs | | | | | | | | |
| appearance | C/T | W/O | C/T | W/O | C/T | W/O | C/T | W/O |

*the wt % of F, P₂O₅, B₂O₃ are based on 100 wt % of the base ingredient.

The coefficient of thermal expansion ranges from −1.36×10⁻⁷/° C. to 13.0×10⁻⁷/° C. for Examples 7, 9, 11 and 13, and from 17.0×10⁻⁷/° C. to 21.0×10⁻⁷/° C. for Examples 8, 10, 12, and 14.

The results of Examples 7-14 are compared to those of the Comparative Examples 7-14.

As clearly seen from Tables 4 and 5, the crystal-growing temperature ranges from 810-840° C. for Examples 8, 10, 12 and 14, which is much lower than that of the Comparative Examples 11-14 (1100-1160° C.). The coefficient of thermal expansions for Examples 7-14 are respectively similar to those of the Comparative Examples 7-14. In addition, the temperature (1550° C.) for melting the raw material for Examples 7-14 is less than that of the Comparative Examples 7-14 (1650° C.).

With the invention thus explained, it is apparent that various modifications and variations can be made without departing from the spirit of the present invention.

We claim:

1. An Li₂O—Al₂O₃—SiO₂ crystallizable glass comprising:
a base ingredient comprising at least Li₂O, Al₂O₃ and SiO₂; and
0.5-4.0 wt % P₂O₅ relative to 100 wt % of the base ingredient.

2. The Li₂O—Al₂O₃—SiO₂ crystallizable glass of claim 1, further comprising 0.5-4.0 wt % B₂O₃.

3. The Li₂O—Al₂O₃—SiO₂ crystallizable glass of claim 1, wherein the base ingredient comprises 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O, the total content of SiO₂ and Al₂O₃ is 80.0-87.0 wt %.

4. The Li₂O—Al₂O₃—SiO₂ crystallizable glass of claim 2, wherein the base ingredient comprises 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O, the total content of SiO₂ and Al₂O₃ is 80.0-87.0 wt %.

5. An Li₂O—Al₂O₃—SiO₂ crystallizable glass comprising:
a base ingredient comprising at least Li₂O, Al₂O₃ and SiO₂; and
1.0-3.0 wt % F relative to 100 wt % of the base ingredient.

6. The Li₂O—Al₂O₃—SiO₂ crystallizable glass of claim 5, further comprising 0.5-4.0 wt % B₂O₃.

7. The Li₂O—Al₂O₃—SiO₂ crystallizable glass of claim 5, wherein the base ingredient comprises 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O, the total content of SiO₂ and Al₂O₃ is 80.0-87.0 wt %.

8. The Li₂O—Al₂O₃—SiO₂ crystallizable glass of claim 6, wherein the base ingredient comprises 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3-0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O, the total content of SiO₂ and Al₂O₃ is 80.0-87.0 wt %.

9. An Li₂O—Al₂O₃—SiO₂ transparent crystallized glass having a β-quartz solid solution produced as a main crystal, the transparent crystallized glass comprising:
a base ingredient comprising at least Li₂O, Al₂O₃ and SiO₂; and
0.5-4.0 wt % P₂O₅ relative to 100 wt % of the base ingredient.

10. The transparent crystallized glass of claim 9, further comprising 0.5-1.5 wt % B₂O₃.

11. The transparent crystallized glass of claim 9, wherein the base ingredient comprises 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O, the total content of SiO₂ and Al₂O₃ is 80.0-87.0 wt %.

12. The transparent crystallized glass of claim 10, wherein the base ingredient comprises 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O, the total content of SiO₂ and Al₂O₃ is 80.0-87.0 wt %.

13. An Li₂O—Al₂O₃—SiO₂ opaque crystallized glass having a β-spodumene solid solution produced as a main crystal, the opaque crystallized glass comprising:
a base ingredient comprising at least Li₂O, Al₂O₃ and SiO₂; and
1.0-3.0 wt % F relative to 100 wt % of the base ingredient.

14. The opaque crystallized glass of claim 13, further comprising 1.0-4.0 wt % B₂O₃.

15. The opaque crystallized glass of claim 13, wherein the base ingredient comprises 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O, and 0-2.0 wt % Na₂O+K₂O, the total content of SiO₂ and Al₂O₃ is 80.0-87.0 wt %.

16. The opaque crystallized glass of claim 14, wherein the base ingredient comprises 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O, the total content of SiO₂ and Al₂O₃ is 80.0-87.0 wt %.

17. A method for producing Li₂O—Al₃O₃—SiO₂ crystallizable glass, the method comprising the steps of:
(a) preparing a raw material by mixing a base ingredient with 0.5-4.0 wt % P₂O₅ relative to 100 wt % of the base ingredient, the base ingredient comprising 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O, , and 0-2.0 wt % Na₂O+K₂O, the total content of SiO₂ and Al₂O₃ being 80.0-87.0 wt %;
(b) melting the raw material; and
(c) shape forming the molten raw material so as to form the Li₂O—Al₂O₃—SiO₂ crystallizable glass.

18. The method of claim 17, wherein the raw material is heated to a temperature ranging from 1540-1600° C. for 6-15 hours in step (b).

19. A method for producing Li₂O—Al₂O₃—SiO₂ crystallizable glass, the method comprising the steps of:
(a) preparing a raw material by mixing a base ingredient with 1.0-3.0 wt % F relative to 100 wt % of the base ingredient, the base ingredient comprising 58.0-65.0 wt % SiO₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O, the total content of SiO₂ and Al₂O₃ being 80.0-87.0 wt %;
(b) melting the raw material; and
(c) shape forming the molten raw material so as to form the Li₂O—Al₂O₃—SiO₂ crystallizable glass.

20. The method of claim 19, wherein the raw material is heated to a temperature ranging from 1520-1600° C. for 6-15 hours in step (b).

21. A method for producing Li₂O—Al₂O₃—SiO₂ transparent crystallized glass having a β-quartz solid solution produced as a main crystal, the method comprising the steps of:
(a) preparing a raw material by mixing a base ingredient with 0.5-1.5% B₂O₃ relative to 100 wt % of the base ingredient and 0.5-4.0 wt % P₂O₅ relative to 100 wt % of the base ingredient, the base ingredient comprising 58.0-65.0 wt % SiO₂, 19.0-26.0 wt % Al₂O₃, 3.7-5.5 wt % Li₂O, 0.54.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O, the total content of SiO₂ and Al₂O₃ being 80.0-87.0 wt %;
(b) heating the raw material to a temperature ranging from 1540-1600° C. for 6-15 hours so as to melt the raw material;
(c) shape forming the molten raw material so as to form a Li₂O—Al₂O₃—SiO₂ crystallizable glass;
(d) heating the Li₂O—Al₂O₃—SiO₂ crystallizable glass to a temperature ranging from 700-760° C. for 1-4 hours for nucleation of the Li₂O—Al₂O₃—SiO₂ crystallizable glass; and
(e) heating the Li₂O—Al₂O₃—SiO₂ crystallizable glass to a temperature ranging from 800-880° C. for 1-3 hours for crystal growth of the Li₂O—Al₂O₃—SiO₂ crystallizable glass so as to form the Li₂O—Al₂O₃—SiO₂ transparent crystallized glass having a β-quartz solid solution produced as a main crystal.

22. A method for producing Li₂O—Al₂O₃—SiO₂ opaque crystallized glass having a β-spodumene solid solution produced as a main crystal, the method comprising the steps of:
(a) preparing a raw material by mixing a base ingredient with 1.0-4.0% B₂O₃ relative to 100 wt % of the base ingredient and 1.0-3.0 wt % F relative to 100 wt % of the base ingredient, the base ingredient comprising 58.0-65.0 wt % Si₂, 19.0-26.0 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O, the total content of SiO₂ and Al₂O₃ being 80.0-87.0 wt %;
(b) heating the raw material to a temperature ranging from 1520-1600° C. for 6-15 hours so as to melt the raw material;
(c) shape forming the molten raw material so as to form a Li₂O—Al₂O₂—SiO₂ crystallizable glass;
(d) heating the Li₂O—Al₂O₃—SiO₂ crystallizable glass to a temperature ranging from 640-720° C. for 0.5-2 hours for nucleation of the Li₂O—Al₂O₃—SiO₂ crystallizable glass; and
(e) heating the Li₂O—Al₂O₃—SiO₂ crystallizable glass to a temperature ranging from 780-890° C. for 0.5-2 hours for crystal growth of the Li₂O—Al₂O₃—SiO₂ crystallizable glass so as to form the Li₂O—Al₂O₃—SiO₂ opaque crystallized glass having a β-spodumene solid solution produced as a main crystal.

23. An Li₂O—Al₂O₃—SiO₂ crystallizable glass comprising:
a base ingredient comprising 58.0-65.0 wt % SiO₂, 19.0-260 wt % Al₂O₃, 3.7-5.5 wt % Li₂O, 0.5-4.0 wt % TiO₂, 1.0-3.0 wt % ZrO₂, 0.2-3.0 wt % MgO, 0-3.0 wt % ZnO, 0-4.0 wt % BaO, 0.4-1.5 wt % As₂O₃, 0-1.5 wt % Sb₂O₃, and 0-2.0 wt % Na₂O+K₂O, the total content of SiO₂ and Al₂O₃ being 80.0-87.0 wt %; and
0.5-4.0 wt % B₂O₃ relative to 100 wt % of the base ingredient.

24. The Li₂O—Al₂O₃—SiO₂ crystallizable glass of claim 23, further comprising 0.5-4.0 wt % P₂O₅ relative to 100 wt % of the base ingredient, the content of B₂O₃ being in an amount of 0.5-1.5 wt % relative to 100 wt % of the base ingredient.

25. The Li₂O—Al₂O₃—SiO₂ crystallizable glass of claim 23, further comprising 1.0-3.0 wt % F relative to 100 wt % of the base ingredient, the content of B₂O₃ being in an amount of 1.0-4.wt % relative to 100 wt % of the base ingredient.
